(19) United States
(12) Patent Application Publication
(10) Pub. No.: US 2019/0286107 A1
(43) Pub. Date: Sep. 19, 2019

(54) MACHINING DEVICE FOR THROUGH-FEED MACHINING, CONTROL APPARATUS AND METHOD

(71) Applicant: HOMAG Bohrsysteme GmbH, Herzebrock-Clarholz (DE)

(72) Inventors: Reinhard HEIMANN, Guetersloh (DE); Markus TENTRUP, Guetersloh (DE); Oliver GERTZEN, Lemgo (DE); Tobias MUELLER, Lemgo (DE); Dennis BURSCH, Bornheim (DE)

(21) Appl. No.: 16/465,532

(22) PCT Filed: Dec. 1, 2017
(86) PCT No.: PCT/EP2017/081171

§ 371 Date: May 30, 2019

(30) Foreign Application Priority Data
Dec. 2, 2016 (DE) 10 2016 224 037.4

(51) Int. Cl. G05B 19/414

(52) U.S. Cl. CPC G05B 19/414; G05B 2219/36454; G05B 2219/45129; G05B 2219/45144; G05B 2219/50233; G05B 2219/45238; G05B 2219/45187; G05B 2219/45165; G05B 2219/45145

(57) ABSTRACT

The present invention relates to a machining device (100), a control apparatus (200) and a method for the continuous machining of workpieces (W₁-W₃), preferably plate-shaped workpieces (W₁-W₃), which preferably consist at least in sections of wood, wood material and/or synthetic material, a synchronization of a movement of a machining aggregate (130) with a feed movement of the workpiece (W₁-W3) being carried out by a first control (201) and a positioning of the machining aggregate (130) according to a preset machining movement being carried out by a second control (202) with electronic cam disc.

### TECHNICAL FIELD

The present invention relates to a machining device, in particular a through-feed machining device, for the through-feed machining of workpieces, as well as to a control apparatus and a method. Machines of such a type are used, for example, in the furniture and component industry to machine furniture parts, panels, doors, windows and the like.

### PRIOR ART

Generally, machining devices are differentiated into two machine classes. There are stationary machining devices and through-feed machining devices. Cycled through-feed machining devices are usually used if there are high quantities and plural machining steps following one after the other.

However, in known cycled through-feed machining devices the problem is that the slowest cycle, i.e. the longest machining process, determines the cycle time and thus the product throughput of the entire through-feed machining device when there are several machining steps in one through-feed machining device and/or of the entire production line. In the prior art, this problem is often solved by switching several identical through-feed machining devices in parallel in order to compensate for the shortage caused by the slow cycle time. However, this is often associated with high acquisition costs, which makes this solution uneconomical in many individual cases of application.

As is shown in FIG. 1, it is necessary, for example in a through-feed milling device as a specific example of a through-feed machining device, that if a circular groove is to be milled in through-feed, the CNC control of the through-feed machining device controls all of the shifting paths of the machining apparatus. For this it is necessary, as shown, to calculate a superimposed movement path 1 (see FIG. 1) of different axes. The loop path shown results from the linear feed movement 2 (see FIG. 2a) of the workpiece, which must be compensated, as well as from the desired annular milling contour 3 (see FIG. 2b). In a known through-feed device, it would thus be necessary that the CNC control simultaneously controls three axes of the machining apparatus according to the calculated loop path. One axis thereof executes the feed movement of the machining aggregate, and the other two axes must show the two-dimensional movement path (loop path). Starting from a desired constant feed speed (conveying speed) of the workpiece of approximately 20 m/min., it is not possible in a conventional CNC control to execute sufficiently quickly the necessary calculations.

The partly high masses of the machining apparatus are another problem when realizing a non-cycled through-feed machining device. For example, in a through-feed drilling device as a specific example of a machining device, the drilling aggregate has an extremely high mass and thus inertia, in particular when several bores (drilling pattern) are to be drilled at the same time. The result of this is that the necessary movement speeds of the machining aggregate, in particular the necessary accelerations, cannot be realized.

### SUBJECT MATTER OF THE INVENTION

It is the object of the present invention to provide a machining device, in particular a through-feed machining device, a control apparatus as well as a method, by means of which a non-cycled machining of workpieces, in particular a high-speed machining, can be ensured with sufficient machining speed and high machining quality.

The object is solved by a machining device according to claim 1, a control apparatus according to claim 15 and a method according to claim 17. Preferred further developments of the invention are given in the dependent claims.

One of the core ideas of the present invention is to perform and control by means of a first control, in particular a CNC control, the synchronization of a movement of a machining aggregate with a through-feed movement of a workpiece, and to control, by means of a second control with electronic cam disc, a positioning of the machining aggregate according to a preset machining movement.

In this manner, it is possible to divide the control of the machining movement of the machining aggregate into two basic functions, in particular a synchronization which carries the machining aggregate with the workpiece at the same speed as the workpiece in the conveying direction and a positioning of the machining aggregate on a preset machining movement.

Due to the separation of these two basic functions, in particular the processing (control) of the two basic functions by separate, per se independent controls, the control effort of the individual control, in particular of the second control with electronic cam disc, can be drastically reduced and thus a sufficiently fast processing (control) can be guaranteed.

According to the present invention, the machining device, in particular the through-feed machining device for the non-cycled machining of preferably plate-shaped workpieces which preferably consist at least in sections of wood, wood material and/or synthetic material, comprises: at least one machining apparatus comprising: at least one machining aggregate for machining the workpiece, a shifting apparatus for shifting the at least one machining aggregate, and at least one control device for the at least one machining device, said control device comprising: a first control, in particular a CNC control, for controlling the synchronization of the movement of the machining aggregate with the through-feed movement of the workpiece, and a second control, in particular with electronic cam disc, for controlling the positioning of the machining aggregate according to the preset machining movement.

The moving apparatus can be configured to synchronize a movement of the machining aggregate with a through-feed movement of the workpiece through the machining device, and to position the machining aggregate according to a preset machining movement relative to the workpiece.

A machining aggregate can comprise a tool or a machining unit, or the workpiece/machining unit can be inserted into the machining aggregate, for example into an interface.

In the context of the present invention, “non-cycled” means that a workpiece is not completely stopped, but moves further. It is preferable that the movement speed remains constant. However, a change of the movement speed is also conceivable.

Within the meaning of the present invention, a control with an electronic cam disc refers to a clear allocation of the positions between a master drive (master) and a slave drive (slave). The master drive can be either a drive, a position encoder or a “virtual master”. The electronic cam disc is based on the basic idea of the generally known mechanic cam disc, in which a linear rotary movement is converted into a random curvilinear movement.

Moreover, a synchronization of the movement of the machining aggregate with the through-feed movement of the workpiece has to be understood, within the meaning of the present invention, such that the machining aggregate is brought to the same feed speed as the workpiece itself during the machining of the workpiece. In other words, if the actual machining movement of the machining aggregate, which is performed during the machining of the workpiece, is not considered, there is no relative movement between workpiece and machining aggregate. Hence, the machining aggregate is moved with the same feed speed as the workpiece itself in the conveying direction.

According to one embodiment of the present invention, the first control, in particular the CNC control, is configured as a higher-level master control (master) and the second control, in particular with electronic cam disc, is configured as a slave control (slave) subordinate to the first control. Therefore the control of the machining positions of the machining aggregate is rigidly coupled to the master control during the machining of the workpiece according to the preset machining movement, and thus the control of the machining aggregate can be highly simplified.

Furthermore, it is preferred that the movement of the machining aggregate for synchronization of the movement of the machining aggregate with the through-feed movement of the workpiece and the movement of the machining aggregate for performing the positioning of the machining aggregate are carried out overlapping with each other according to the preset machining movement. This means that both movements are performed simultaneously, i.e. controlled simultaneously by the first master control (master) and the second slave control (slave).

According to a further embodiment, the machining device is configured to perform at least a 3-sided through-feed machining, preferably a 4-sided through-feed machining, further preferably a 5-sided through-feed machining, in particular further preferably a 6-sided through-feed machining of the workpiece.

This makes it possible to machine all sides of a workpiece in the smallest possible space, in particular by using only one machining device. This leads to a further reduction of acquisition costs since there is no need to provide separate machining devices for different sides or groups of sides.

It is further preferred that at least one of the following machining operations of the workpiece can be carried out by the machining device: horizontal drilling, vertical drilling, sawing, milling, coating, gluing, printing, laser machining, and the like.

According to a further embodiment of the present invention, the second control is configured to receive a start signal from the first control and, after receipt of the start signal, to control the moving apparatus according to the preset machining movement, in particular a recorded machining path. By this, the rigid coupling of the slave with the master, i.e. of the machining movement with the movement for synchronizing the movement of the machining aggregate with the movement of the workpiece, can be ensured.

Furthermore, the machining device can comprise a conveying apparatus for conveying the workpieces in a conveying direction, and a control for controlling the feed movement of the workpieces. It is preferred that the control for controlling the feed movement of the workpieces is identical to the first control.

Accordingly, the control for controlling the feed movement of the workpieces/workpiece constitutes the master control and thus emits the start signal for the slave control, by which start of machining is controlled.

According to a further embodiment of the present invention, the machining device is provided with at least two or more machining apparatus, with each machining apparatus comprising a separate second slave control with an electronic cam disc of its own, by means of which the control of the positioning of the machining aggregate is carried out according to the preset machining movement.

Accordingly, the machining movements (movement sequences) of the individual machining apparatus can be coupled to the master control (first control) via respective electronic cam discs, and thus the individual machining operations by the machining apparatus can be coupled to the movement (conveying movement) of the workpiece. As a result, it can be ensured that the machining operations performed on the workpiece are carried out at the correct positions on the workpiece.

Furthermore, it is preferred that the moving apparatus is configured to shift the machining aggregate in at least two directions, preferably in three directions, which are oriented approximately orthogonal to one another, in order to be able to feed the machining aggregate to the workpiece to be machined and to be able to execute the preset machining movement, in particular to be able to depict a two-dimensional machining contour.

In addition, the at least one machining apparatus can comprise at least one first drive, in particular a servo motor, a stepper motor or a DC motor, for driving the machining aggregate and at least two second drives, in particular servomotors, step motors or DC motors, for driving the moving apparatus.

Due to the fact that each machining apparatus is equipped with the necessary drives, each machining apparatus is designed as an autonomous unit that can shift or carry out a machining operation independently of the other machining apparatus. The machining sequences can be designed with corresponding flexibility.

Furthermore, it is preferable that if at least two or more machining apparatus are provided, said apparatus are arranged one behind the other in the conveying direction and carry out machining operations on the workpiece independently of each other and one after the other, in particular different machining operations such as horizontal drilling, vertical drilling, sawing, milling, coating, gluing, printing, laser machining and the like.

In this way, the complete machining of the workpiece can be carried out in modules, i.e. the individual machining operations can be divided into modules (machining sections). For example, with a through-feed drilling device as a specific example of a through-feed machining device, it is possible to divide the machining operations into the following modules: module 1=construction drilling, module 2=horizontal drilling, module 3=hole-line drilling, module 4=special drilling (matrix), module 5=vertical drilling, etc. The individual modules can be realized here by the respective machining apparatus. This offers the advantage that the individual machining apparatus can be designed more compactly, thus reducing their mass and the associated inertia. Moreover, the control effort for the single second control (slave control) can be reduced by this and thus a sufficient machining speed can be ensured.

According to a further embodiment of the present invention, a machining apparatus has at least two or more machining aggregates which simultaneously perform the same or a similar machining operation on the workpiece. This is useful, for example, if bores of the same size or at least approximately the same size must be provided on a workpiece, especially on one side. Thus, the number of the individual machining apparatus and, in particular, the number of the required controls (slave controls) can be reduced. Depending on the performance of the individual controls and the complexity of the respective machining operations, it is in principle possible to control several machining apparatus by a second control (slave control).

Furthermore, it is preferred that at least the drives of the shifting apparatus are designed as direct drives. This offers the advantage that an additional gear can be dispensed with and thus the manufacturing tolerance of the machining can be improved since a possible gear backlash can be avoided. This further contributes positively to the weight reduction of the individual machining apparatus.

Moreover, it is preferred that the machining device is provided with a synchronization apparatus that is configured to detect, before the machining of the workpiece starts, a feed movement of the workpiece and to transmit a detected result to the first control or the first control of the respective machining apparatus.

Furthermore, the present invention relates to a control unit for controlling a non-cycled machining of preferably plate-shaped workpieces which preferably consist at least in sections of wood, wood material and/or synthetic material, in particular for controlling the machining device described above, comprising: a first control, in particular a CNC control, for controlling a synchronization of a movement of a machining aggregate with a through-feed movement of the workpiece, and a second control, in particular with electronic cam disc, for controlling a positioning of the machining aggregate according to a preset machining movement.

According to a further embodiment of the control apparatus of the present invention, the first control sends a start signal to the second control, the start signal preferably including at least one of the following pieces of information: workpiece identification number, machining type, machining data, identification of the desired electronic cam disc by the second control, start time or delay time and the like.

The present invention furthermore relates to a method for the non-cycled machining of preferably plate-shaped workpieces which preferably consist at least in sections of wood, wood material and/or synthetic material, in particular by using the machining device described above, the method comprising: a first operation for synchronizing a movement of a machining aggregate with a feed movement of the workpiece by means of a first control, in particular by a CNC control, and a second operation for positioning the machining aggregate according to a preset machining movement by means of a second control with electronic cam disc.

According to a further embodiment of the present invention, the method described above further comprises the detection of the feed movement of the workpiece before machining of the workpiece starts, with the synchronization of the movement of the machining aggregate with the feed movement of the workpiece being carried out by the first control based on the detected result.

### BRIEF DESCRIPTION OF THE FIGURES

FIG. 1 shows an example of an overlapped movement path for milling an annular groove in the through-feed process,

FIGS. 2a and 2b show a division of the superimposed movement path from FIG. 1 into a synchronization movement (FIG. 2a) and a machining movement (FIG. 2b),

FIG. 3 shows a through-feed machining device according to one embodiment of the present invention, in which several modules are machined one after the other,

FIG. 4 shows an enlarged section of the through-feed machining device shown in FIG. 3 according to one embodiment of the present invention,

FIG. 5 schematically shows the structure of a control apparatus according to one embodiment of the present invention.

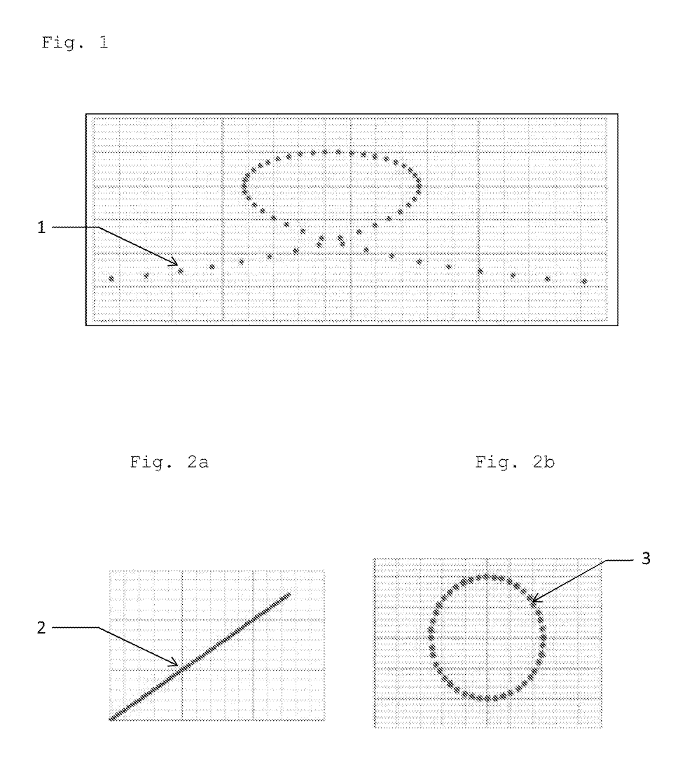

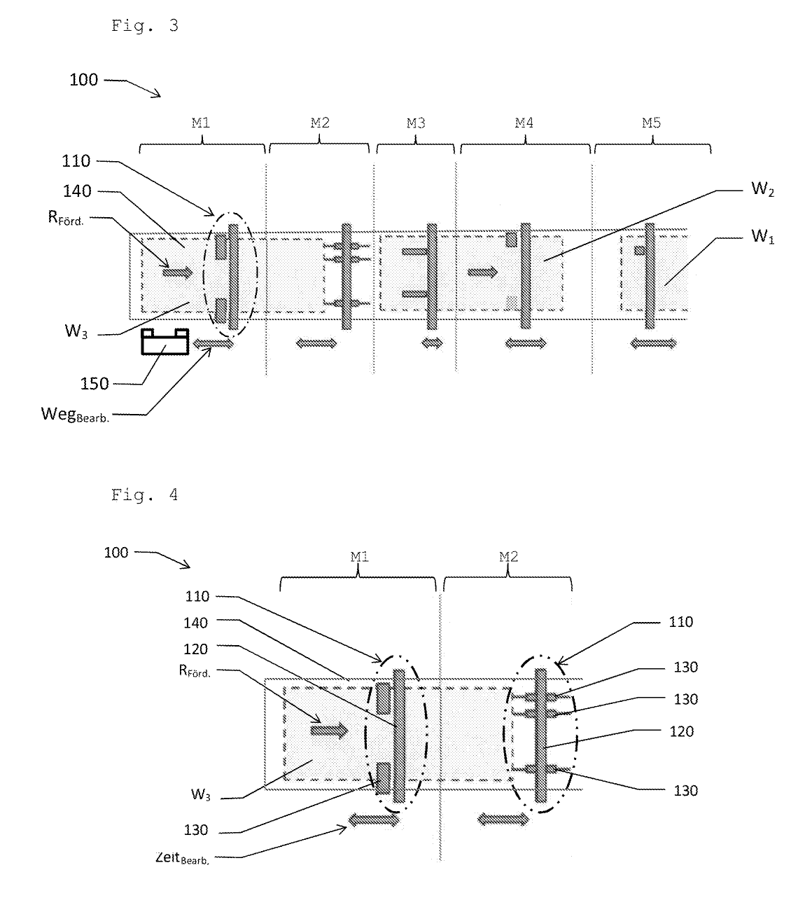

### DETAILED DESCRIPTION OF THE PREFERRED EMBODIMENTS

Preferred embodiments of the present invention are described below in detail by means of the enclosed figures. Further modifications of certain features mentioned in this context can each be combined with one another in order to form new embodiments.

FIG. 3 shows a through-feed machining device 100, when viewed from above, according to one embodiment of the present invention. The through-feed machining device 100 shown is a through-feed drilling device 100 as a specific example of a through-feed machining device.

By means of the through-feed drilling device 100 shown, workpieces W1, W2, W3 that are conveyed from the left to the right in the conveying direction RFörd. through the through-feed drilling device 100 are machined by five successive modules M1 to M5. The machining operations to be performed by modules M1 to M5 are divided, for example in terms of manufacturing technology, into module M1=construction drilling, module M2=horizontal drilling, module M3=hole-line drilling, module M4=special drilling (matrix), module M5=vertical drilling. It is clear that a different division is possible, for example according to the required machining time.

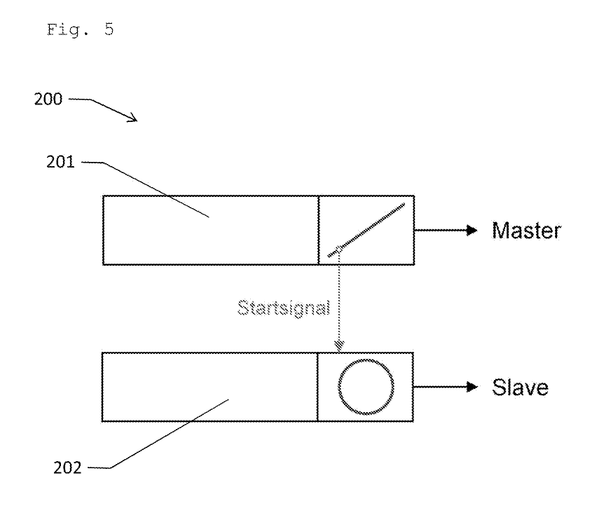

It can also be taken from FIG. 3 that three workpieces W1 to W3 are machined at the same time in the present through-feed drilling device 100. The through-feed drilling device is provided with five separate machining apparatus 110 to machine each single module M1 to M5. As can be seen in FIG. 4, which shows an enlarged section of FIG. 3, said machining devices 110 each have a shifting apparatus 120 as well as at least one machining aggregate 130. The machining aggregate 130 can comprise a tool, or a tool is insertable into a corresponding interface of the machining aggregate 130.

In the embodiment shown, the first two machining apparatus 110 machine the workpiece W3 that was last inserted into the through-feed drilling device 100, the second and third machining apparatus 110 machine the workpiece W2 that was previously inserted, and the fifth machining apparatus 110 machines the workpiece W1 which was first inserted.

Here, for example, the first machining apparatus 110 performs the construction drilling of module 1 and the second machining apparatus 110 performs the horizontal drilling of module 2. Both machining operations are carried out simultaneously on the same workpiece W3. As can be seen from the arrows WegBearb., the machining path, and thus the machining time, for executing the construction drilling (module M1) is approximately identical to the machining path (WegBearb.) for the horizontal drilling (module M2). Accordingly, the machining by the two machining apparatus 110 takes approximately the same time.

The second workpiece W2 is machined simultaneously by the third and fourth machining apparatus 110. Here, the third machining apparatus 110 performs the hole-line drilling (module M3) and the fourth machining apparatus 110 performs the special drilling (module M4). As is also schematically shown by the arrows WegBearb., the machining path (WegBearb.) of the third machining apparatus is shorter than that of the fourth machining apparatus. The third machining apparatus is accordingly shorter in use.

At the end of the through-feed drilling device 100, only the fifth machining apparatus 110 performs a machining operation on the workpiece W3 that was first inserted. The last machining apparatus 110 of the through-feed drilling device executes the vertical drilling (module M5). After that, the completely machined workpiece W is emitted from the through-feed drilling device 100 and is available for further machining by another device if necessary.

The through-feed device shown simply performs drilling operations, and it is therefore just a through-feed drilling device. However, it is also conceivable to carry out various machining operations in one through-feed device. For example, it is possible to carry out simultaneously drilling machining, milling and/or sawing machining, coating machining and the like in one through-feed device.

It should be noted, however, that the individual machining times are approximately the same so as not to unnecessarily slow down the through-feed device due to a machining operation that is erratically longer than the other machining operations. This means that if, for example, a relatively long milling contour is to be incorporated onto the workpiece W, it must be ensured that the machining speed of the machining apparatus with the milling cutter is sufficiently high to achieve a machining time equal to that of the other machining apparatus despite the long milling contour and the associated long machining path.

If this is not possible, a machining operation, for example the milling of a long milling contour, can alternatively be divided into two modules, i.e. two machining apparatus. Moreover, it is also possible, if the shifting paths so permit, to have a machining operation (milling contour) carried out using different machining aggregates 130 of one machining apparatus 110.

FIG. 5 shows a schematic structure of a control apparatus 200 according to one embodiment of the present invention. In the embodiment shown, the first control 201 is realized as a CNC control and the second control 202 as a control with a cam disc. Accordingly, the CNC control 201, which functions as master drive, sends a start signal to the second control 202 after detecting a workpiece W1-W3 to be machined. A corresponding start signal is generated by the first control 201, preferably based on the detected workpiece data of the workpiece W1-W3 to be machined, such as workpiece type, workpiece dimensions, feed speed and the like. Preferably, the start signal includes information such as machining type, machining data, identification of the desired electronic cam disk by the second control 202, start time or delay time and the like.

Accordingly, the second control 202 receives information from the start signal as to which machining operation is to be carried out by the machining aggregate 130 and which electronic cam disc stored in the second control is to be used to that end. In the embodiment shown, the second control 202 receives the start signal from the CNC control 201 to mill a circular contour. If the through-feed device is equipped with several machining apparatus 110, which successively carry out machining operations on the workpiece W1-W3, in particular different machining operations, it is preferred that the CNC control 201 simultaneously sends a start signal for a specific workpiece W1-W3 to all of the machining apparatus, i.e. to the respective second controls 202 of the machining apparatus 110. In this case, it is necessary to send a start time or delay time, together with the start signal, to the respective second control 202 to ensure that the correct workpiece W1-W3 is machined in the correct machining apparatus 110.

Alternatively, it is possible that the CNC control 201 only transmits the start signal with the necessary information to the respective machining apparatus 110 when the corresponding workpiece W1-W3 has arrived. In this case, the CNC control 201 can transmit the start signal to the second control 202 at the exact time when machining is supposed to start.

1. A machining device for the non-cycled through-feed machining of plate-shaped workpieces, comprising:
at least one machining apparatus comprising:
at least one machining aggregate for machining the workpiece, and a shifting apparatus for moving the at least one machining agregate, and
at least one control apparatus for the at least one machining apparatus, comprising:
a first control for controlling the synchronization of the movement of the at least one machining aggregate with the through-feed movement of the workpiece, and
a second control for controlling the positioning of the at least one machining aggregate according to a preset machining movement.

2. The maching device according to claim 1, wherein the first control is a higher-level master control and the second control with electronic cam disc is a slave control subordinate to the first control.

3. The maching device according to claim 1, wherein h the movement of the machining aggregate for synchronizing the movement of the machining aggregate with the through-feed movement of the workpiece and the movement of the machining aggregate for performing the positioning of the machining aggregate according to the preset machining movement are carried out to overlap with each other.

4. The maching device according to claim 1, configured to perform at least a 3-sided through-feed machining of the workpiece.

5. The maching device according to claim 1, configured to perform at least one of the following machining steps:
horizontal drilling, vertical drilling, sawing, milling, coating, gluing, printing, laser machining and the like.

6. The maching device according to claim 1, wherein h the second control is configured to receive a start signal from the first control so as to control, after receipt of the start signal, the shifting apparatus according to the preset machining movement.

7. The maching device according to claim 1, further comprising:
a conveying apparatus for conveying the workpieces in a conveying direction; and
a control for controlling the through-feed movement of the workpieces.

8. The maching device according to claim 1, wherein h if at least two or more machining apparatus are provided, each machining apparatus comprises a separate second control to control the positioning of the machining aggregate according to the preset machining movement.

9. The maching device according to claim 1, wherein h the shifting apparatus is configured to shift the machining aggregate in at least two directions approximately orthogonal to each other.

10. The maching device according to claim 1, wherein h the at least one machining apparatus further comprises at least one first drive for driving the machining aggregate, and at least two second drives for driving the shifting apparatus.

11. The maching device according to claim 1, wherein h, if at least two or more machining apparatus are provided, the machining apparatus are arranged one behind the other in the conveying direction and independently execute, one after the other, machining operations on the workpiece.

12. The maching device according to claim 1, wherein h a machining apparatus comprises at least.

13. The maching device according to claim 1, wherein h at least the drives of the shifting apparatus are designed as direct drives.

14. The maching device according to claim 1, further comprising a synchronization apparatus configured to detect a feed movement of the workpiece.

15. A control apparatus for controlling a non-cycled machining operation of workpieces, for controlling the machining device according to claim 1, comprising:
a first control for controlling a synchronization of a movement of a machining aggregate with a through-feed movement of the workpiece; and
a second control for controlling a positioning of the machining aggregate according to a preset machining movement.

16. The control apparatus according to claim 15, wherein h the first control sends a start signal to the second control, wherein the start signal includes at least one of the following pieces of information: workpiece identification number, machining type, machining data, identification of the desired electronic cam disc by the second control 202, start time and/or delay time and the like.

17. A method for the non-cycled machining of workpieces using the machining device according to claim 1, wherein the method comprises:
a first step for synchronizing a movement of a machining aggregate with a feed movement of the workpiece by a first control; and
a second step for positioning the machining aggregate according to a preset machining movement by a second control.

18. The method according to claim 17, further comprising:
detecting the feed movement of the workpiece before machining of the workpiece starts, wherein based on the detected result the synchronization of the movement of the machining aggregate with the feed movement of the workpiece is performed by the first control.

19. The machining device according to claim 1, wherein the workpieces are plate-shaped, or wherein the first control is a CNC control, or wherein the second control comprises an electronic cam disc.

20. The machining device according to claim 4, wherein the at least 3-sided through-feed machining is a 4-sided through-feed machining or a 6-sided through-feed machining of the workpiece.

21. The machining device according to claim 6, wherein the preset machining movement corresponds to a recorded machining path.

22. The machining device according to claim 7, wherein the control for controlling the feed movement of the workpieces is identical to the first control.

23. The machining device according to claim 8, wherein the separate second control comprises an electronic cam disc.

24. The machining device according to claim 9, wherein the at least two directions is three directions.

25. The machining device according to claim 10, wherein the at least one first drive comprises a servomotor, a stepper motor or a DC motor, or wherein the at least two second drives comprise servomotors, stepper motors or DC motors.

26. The machining device according to claim 11, wherein the machining operations comprise at least one of horizontal drilling, vertical drilling, sawing, milling, coating, gluing, printing or laser machining.

27. The machining device according to claim 12, wherein the two or more machining aggregates perform one machining operation, corresponding to a same machining operation, on the workpiece.

28. The machining device according to claim 14, wherein the synchronization apparatus is configured to detect the feed movement of the workpiece before machining of the workpiece starts, is configured to transmit a detected result to the first control.

29. The control apparatus according to claim 15, wherein the workpieces are plate-shaped and consist at least in sections of wood, wood material and/or synthetic material, or wherein the first control is a CNC control, or wherein the second control comprises an electronic cam disc.

30. The method of claim 17, wherein the workpieces are plate-shaped and consist at least in sections of wood, wood material and/or synthetic material, or wherein the first control is a CNC control, or wherein the second control comprises an electronic cam disc.
